(19) United States
(12) Patent Application Publication
(10) Pub. No.: US 2002/0046095 A1
(43) Pub. Date: Apr. 18, 2002

(54) System and method for increasing retention of advertisement information

(76) Inventor: Clyde Riley Wallace, Cape Coral, FL (US)

Correspondence Address: Clyde Wallace, 5241 Savoy Ct, Cape Coral, FL, 33904, US

(21) Appl. No.: 09/799,365

(22) Filed: Mar. 5, 2001

Related U.S. Application Data
(60) Provisional application No. 60/187,205, filed on Mar. 3, 2000.

(51) Int. Cl. G06F 17/60; G09B 3/00

(52) U.S. Cl. 705/14; 434/332

(57) ABSTRACT

A system and method for increasing participant retention of advertisement information, including one or more advertisements for presentation to one or more participants; associated with each of said one or more advertisements, one or more questions for presentation to said one or more participants, the one or more questions being conclusively answerable based on the information contained in an associated advertisement; and a prize awarded to at least one of said one or more participants. Optionally, the present invention may be embodied in whole or in part in computer-readable media tangibly embodying a program of instructions executable by a computer. Also optionally, presenting and submitting may occur in whole or in part over one or more communication networks. Also optionally, a timer may be utilized to measure how fast each of said one or more participants submits answers.

### RELATED APPLICATION

This application claims the priority of Provisional application No. 60/187,205 having a filing date of Mar. 3, 2000.

### FIELD OF INVENTION

The present invention relates to skill contests, trivia games, standardized tests and advertisements; and more particularly, to a system and method for increasing retention of advertisement information by testing participants on the information contained in advertisement.

### BACKGROUND OF THE INVENTION

Generally, a skill contest is a game that includes an element of prize (redeemable points, awards, chances, things of value, advancement to another round or level, the opportunity to move a game piece, etc.) and an element of bona fide skill known and possessed by the general class of entrants, with the element of skill being determinative and controlling of the final result.

A skill contest may be conducted in whole, or in part, over a network (e.g., the Internet, television, cable television, radio, telephone, etc., and various combinations thereof). For example, in a radio-based contest, ten (10) songs in a row may be broadcast simultaneously to all participants without disclosing the respective band names and song titles, with the first participant who telephones the radio station after the tenth song with the correct band names and respective song titles of all ten (10) songs winning a prize.

A trivia game includes one or more questions for one or more players to answer. A trivia game may also include an element of prize, with the players winning a prize when they provide a correct answer to one or more trivia questions presented. A trivia game may also include an element of time. For example, after a question is presented to two or more players, the first player to initiate some event (e.g., activation of a “buzzer” or a switch) is given the opportunity to answer a question before the other player(s). As another example, the prize a player receives for correctly answering a question may be based on how quickly the player submits the correct answer (e.g., the faster a player answers correctly, the greater the awarded points).

Standardized tests are used to measure various performance levels of test takers. One type of standardized test includes the presentation of printed material with one or more questions (multiple choice, true-false, fill-in-the-blank, etc.) relating to the printed material. This type of test may also be timed, with the test takers being given a fixed amount of time (e.g., three hours) in which to read the content and answer the questions presented.

Advertisements are used to promote products and services and contain information about one or more products and/or services. Advertisements may be embodied in print media (e.g., black & white and color newspaper ads, magazine ads, flyers, etc.) or multi-media (e.g., black & white and color television commercials, computer animations, movie clips, etc.). Also, advertisements may be embodied in radio transmissions (audio only) or even scented materials (i.e., “scratch and sniff”). Further, advertisements may be embodied in various combinations thereof.

It is desirable for an advertisement to be read, viewed, heard or otherwise experienced by its respective target audience so that the advertisement may have a promotional effect. Therefore, it is desirable for an advertisement to obtain the attention of its respective reading, viewing, listening and/or otherwise experiencing audience. However, even where the attention of target audience members are obtained, the information contained in an advertisement may not be fully appreciated, understood and/or remembered by one or more of the members because the members may either shift their attention away from the advertisement or simply fail to pay close attention thereto.

Therefore, there is a need to increase the retention of information contained in advertisements by respective target audiences.

### SUMMARY OF THE INVENTION

A novel system and method for increasing participant retention of advertisement information, the system and method including one or more advertisements for presentation to one or more participants; associated with each of said one or more advertisements, one or more questions for presentation to said one or more participants, the one or more questions being conclusively answerable based on the information contained in an associated advertisement; and a prize awarded to at least one of said one or more participants.

Optionally, the present invention may be embodied in whole or in part in computer-readable media tangibly embodying a program of instructions executable by a computer. Also optionally, the present invention may be practiced in whole or in part over one or more communication networks. Also optionally, a timer may be utilized to measure how fast each of said one or more participants submits answers.

“for each of the one or more Players”=each player may participate at different times;

During a round of play, for each of the one or more players, a player is first presented with a compilation of content to review; the player is then presented with at least one of the one or more questions relating to the content contained in the presented compilation, with the timer being started. The player then submits an answer to each of the presented one or more questions, with the timer being stopped and a time assigned to the player. A player may be a winner if the player submits the most correct answers to the one or more questions presented to the player in the shortest amount of time. There may be more than one winner per round, i.e., the top 2 players, the top 3 players, etc.

Optionally, the present invention may be conducted over a network (e.g., the Internet; an intranet; television, radio, telephone, etc., and combinations thereof).

In an alternative embodiment, a compilation of content is an advertisement, with the timer being started either when a player is presented with a compilation of content or when a player is presented with one or more questions.

Other desires, features and advantages of the present invention will be apparent from the accompanying drawings and the detailed description that follows.

### BRIEF DESCRIPTION OF THE DRAWINGS

The present invention is illustrated by way of example and not limitation in the figures of the accompanying drawings in which like references indicate similar elements and in which:

FIG. 1 shows the provides a high-level perspective of the present invention;

FIG. 2 shows . . . ;

### DETAILED DESCRIPTION

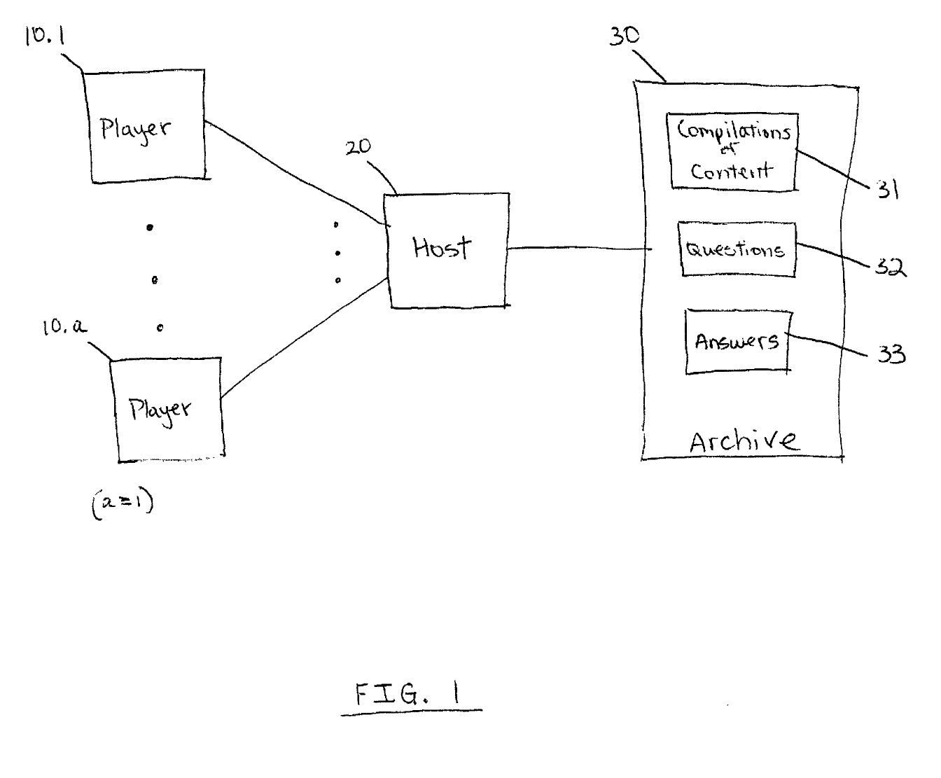

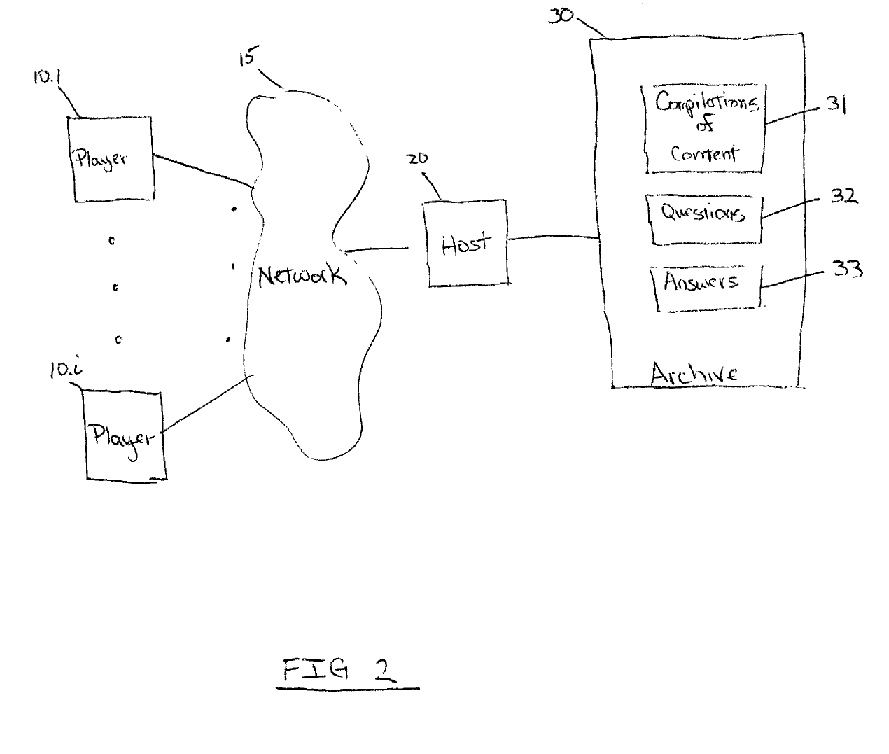

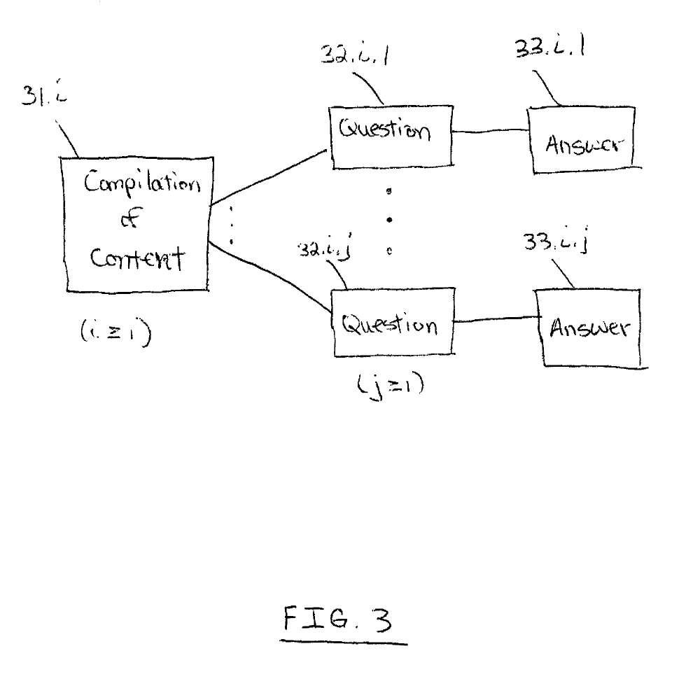

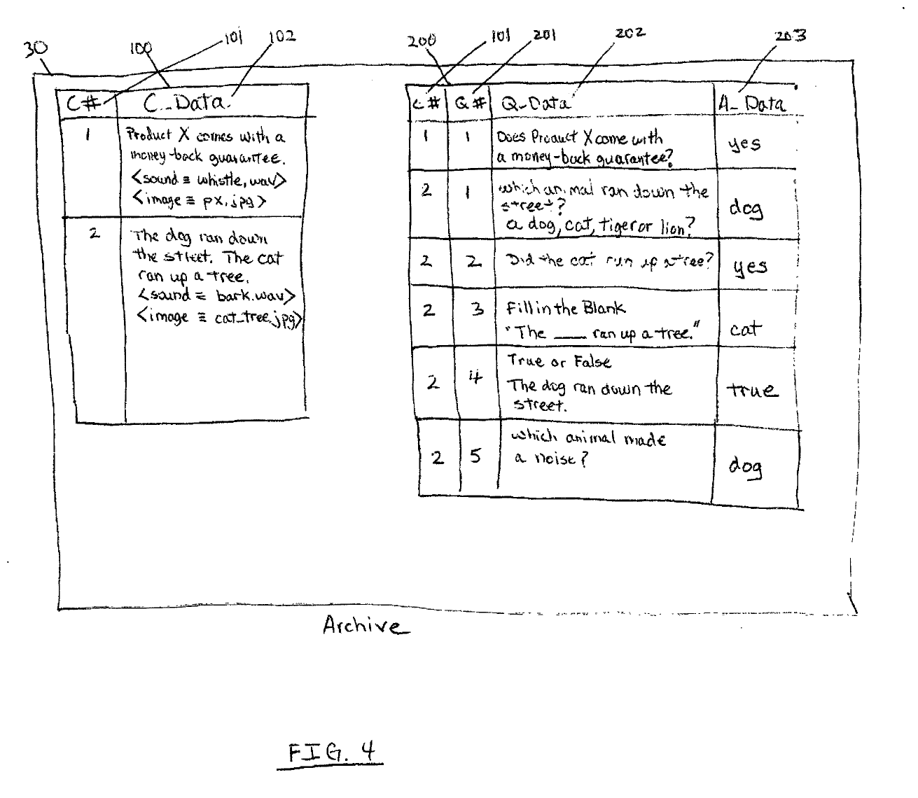

As shown in FIG. 1, the present invention includes one or more players 10.1-10.a (for a >1), a contest host 20, and an archive 30. An archive 30 contains one or compilations of content 31; associated with each compilation 31, one or more questions 32 relating to the associated compilation 31; and associated with each of the one or more questions 32, a correct answer 33 to the associated question 32.

While there may only be one player 10.1 (a=1), it is preferable to have two or more players 10.1 and 10.a (a >1) to create a more direct competitive environment, which may make the present invention more exciting and fun. A player 10 may be a person or a group of persons (i.e., a team). Further, players 10 may be located remotely or together; and may play in a round simultaneously or at different times.

A contest host 20 may be a person, a computer, or both (e.g., a person with the assistance of a computer). The purpose of a contest host 20 is to administer the present invention. As described in further detail below, a host 20 may perform administrative tasks of the present invention, such as

[symbol]

selecting a compilation of content from the archive

sequential, randomize first

random

exhibit the compilation of content

hand it over

display on a computer monitor or the like

select a question

same as compilation

exhibit the question

hand it over

display it on a computer monitor or the like

receive a submitted answer

player types in answer & hits submit button/activate switch/raises

hand/speak, or the like

selects a box & hits submit button/activate switch

compare submitted answer with correct answer

retrieve correct answer from archive, compare

measure performance times of players

from start time to stop time

Further, a contest host 20 may also be more than one person, computer, or both; with the persons, computers, or combinations sharing tasks independently or cooperatively. Also, a contest host 20 may be in whole, or in part, one or more players. For example, players may take turns acting as a host, or one or more players may assume certain roles of a host 20 (e.g., selecting a compilation of content and/or question, starting a timer, stopping a timer, keeping track of times, etc.).

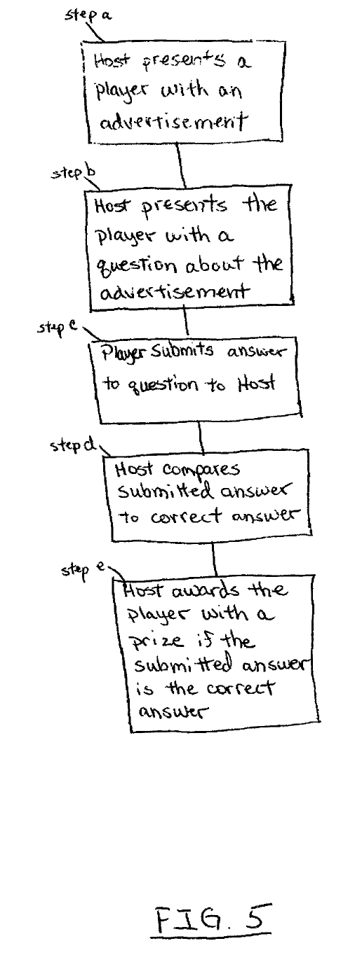

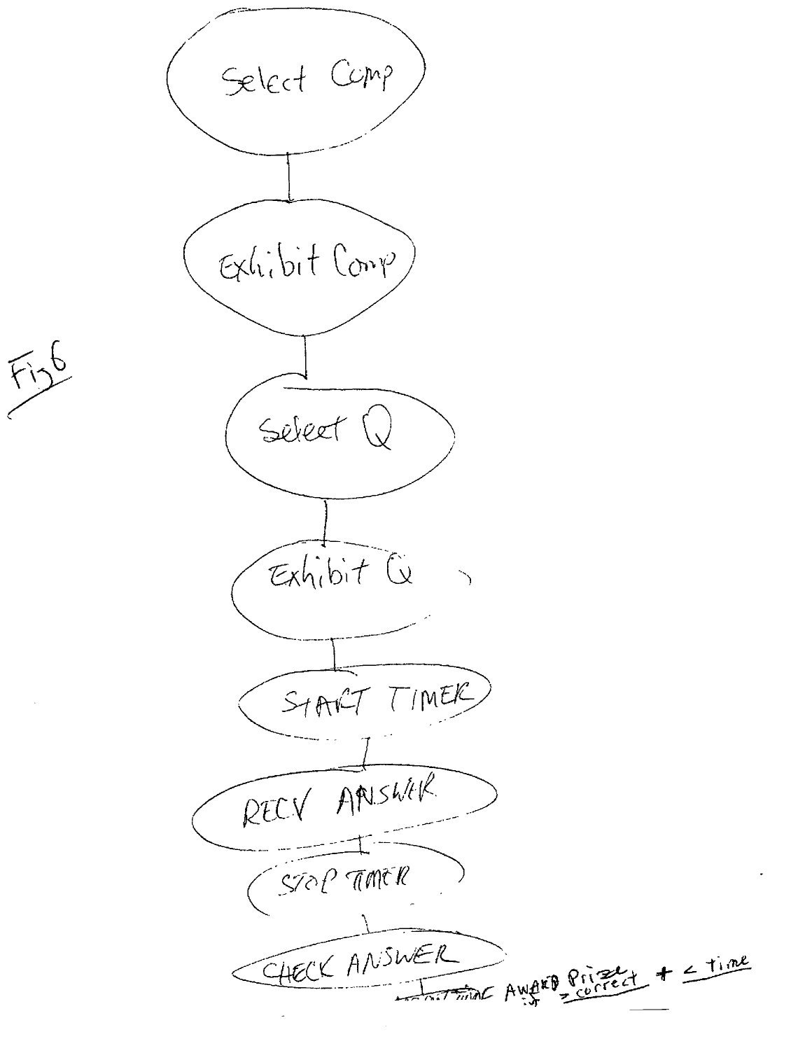

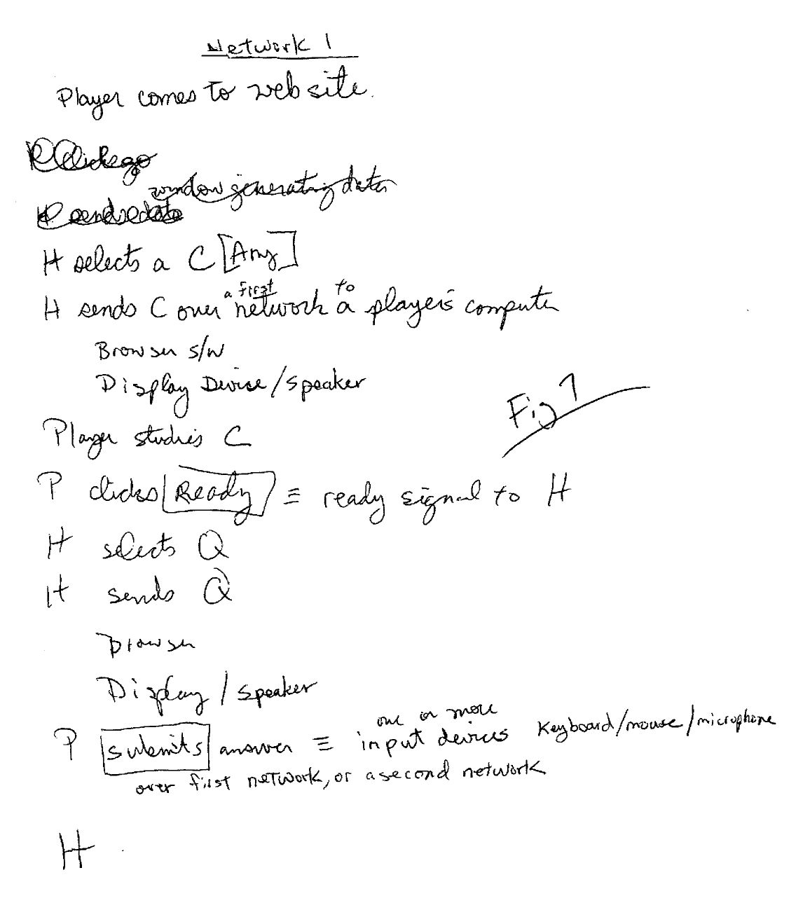

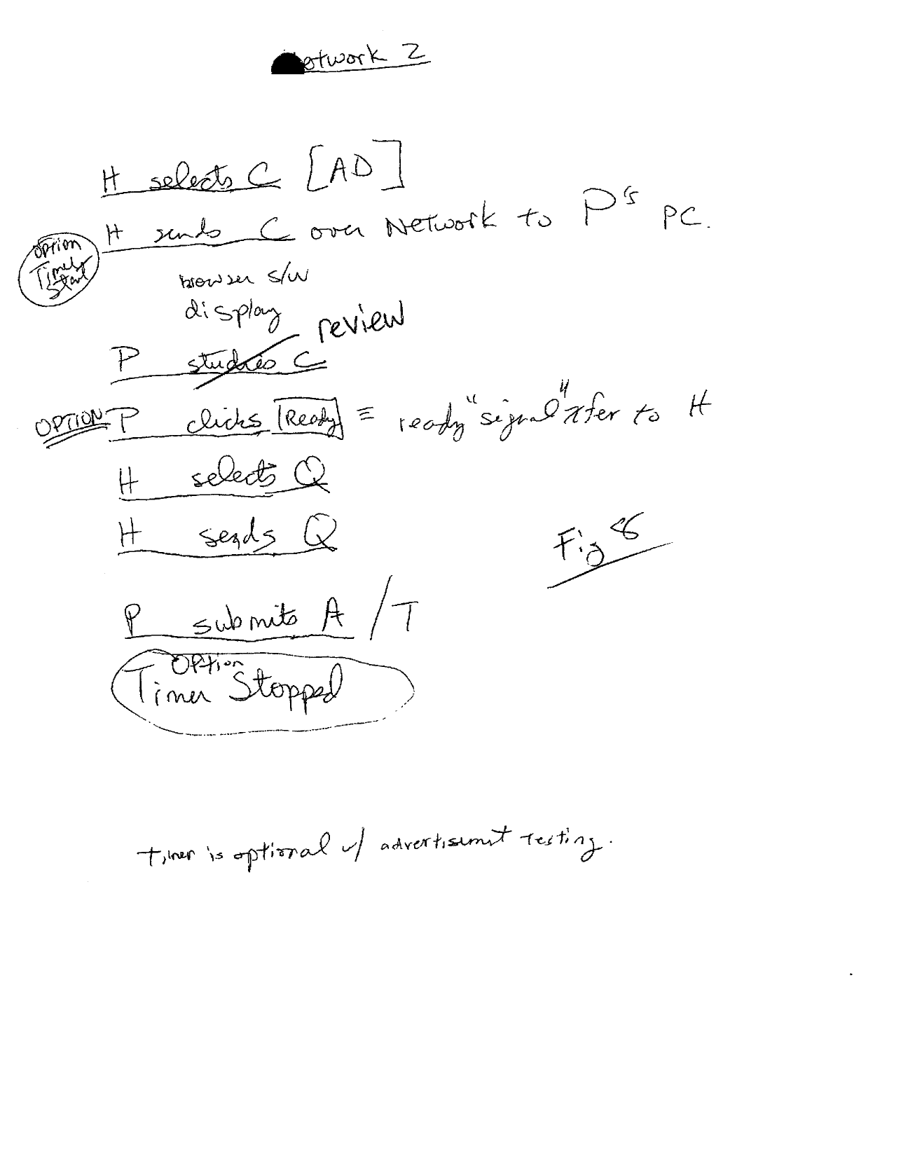

As shown in FIG. 2, optionally, the present invention may be conducted over one or more networks 15 (e.g., the Internet, an intranet, a telephone network, a television network, radio network, and various combinations thereof.) Where the present invention is conducted over a network 1 5, a player 1 0 must have appropriate hardware (computer, telephone, television, etc.) in addition to a network connection to review compilations of content and questions, and to submit answers. For example, using a computer network would require players to have a computer with an input device and one or more devices to review a compilation of content (e.g., display device and/or sound card & speakers); using a telephone network would require players to have a telephone; etc. Where the present invention is conducted over a computer network, a host 20 may be a computer server.

As shown in FIG. 3, the present invention includes one or more compilations of content 31.i (for i>1). A compilation of content 31 contains one or more instances of content, where content may be any type of content found in traditional advertisements (print media) or more modern advertisements (multi-media); and may be cover any type of subject, including but not limited to, product and/or service promotions, history, mathematics, grammar, science, geography, trivia-based subject matter, current events, etc. Furthers a compilation of content 31 may be an Internet web site.

Referring again to FIG. 3, associated with each compilation of content 31.i are one or more questions 32.i.j (for j≧1) relating to the content contained in the associated compilation 31.i; and associated with each question 32.i.j, a correct answer 33.i.j. It is important to note that each compilation 31.i (for i>2) may have a different number of questions 32 associated therewith, as long as each compilation 31.i has at least one question 32 associated therewith.

A question 32 may be any type of question; such as, multiple choice, yes/no, true/false, fill-in-the-blank, or any other known or obvious type of question (e.g., the JEOPARDY™ game show uses questions in the form of answers and answers in the form of questions). Further, a question 32 may also include one or more incorrect answer choices; e.g., multiple choice questions and true-false questions.

A correct answer 33 will be dictated by its associated question 32.

According to the present invention, an archive 30 may use any known or obvious storage medium, or combinations, capable of effectuating the present invention as claimed. It should be noted that the particular medium employed may be limited by the particular type of content to be stored. For example, multi-media requires a medium capable of embodying sounds and/or video (cassette tapes, video tapes, computer disks, DVD, CD-ROM, etc.); and print media may be stored either on the same mediums as multi-media, or a paper-based medium or the like. Association between compilations 31, questions 32 and answers 33 may be achieved via a plurality of techniques, such as by alphanumeric codes (e.g., FIG. 3), color coding, order of organization, and other known or obvious association techniques.

In a preferred embodiment, archive 30 is a computer database for the storage and retrieval of compilations 31, questions 32 and answers 33. A plurality of types of databases (relational, hierarchical, star, etc.) and association techniques (pointers, indexes, primary keys, machine addresses) may be used.

As shown in FIG. 4, preferably archive 30 is a computer database having a compilation table 100 and a question-answer table 200. A compilation table 100 may include a C# field 101 for storing primary keys used to access compilations of content; and a C_Data field 102 for storing a compilation of content. A question-answer table 200 may include a C# field 101 and a Q# field 201 for storing primary keys used to access a question and an answer; and a Q_Data field 202 and an A_Data field 203 for storing a question and answer, respectively.

Similarly, archive 30 may be paper-based. For example, one or more sheets of paper or cards (e.g., index cards) may have imprinted thereon a compilation of content containing information; one or more questions relating to the content contained in the compilation; and a correct answer for each question. A compilation 31, associated question or questions 32 and answers 33 may individually or in combination span one or more sheets of paper or cards.

The present invention also includes a timer for measuring time, such as a stop watch, an hour glass, one or more computer clocks, a computer software timer, or other known or obvious forms of timers. A timer may use any real unit of time, such as hours, minutes, seconds and fractions of a second (e.g., 1/10 of a second, 1/100 of a second, 1/1000 of a second, etc.) Further, discrete units of time may also be employed to the extent desired (e.g., the number of times a counter is incremented, etc.).

According to the present invention, a timer is used to measure an elapsed amount of time during which a player either submits answers to one or more questions presented, or reviews a compilation of content and submits answers to one or more questions presented. The former timing protocol applies where the compilation of content relates to any type of subject, and the latter timing protocol applies where the compilation of content is limited to advertisements.

Where the present invention is conducted over a computer network, a timer is preferably implemented with one or more computer clocks. A computer clock may be located at a host computer (computer server), a player's computer or a third party's computer.

Performance score is determined by the number of correct answers submitted and/or the speed in which answers are submitted.

As shown in FIG. 5,

the timer may be started:

1. when question/compilation is sent by host to player (server clock)

2. when question/compilation is received by player (player clock)

3. when question/compilation is displayed (player clock); and the timer may be stopped:

1. when answer is sent by player to host (player clock)

2. when question/compilation is received host (server clock)

A prize may be any form of prize; such as, redeemable points, coupons, awards, chances, money, things of value, advancement to another round, the opportunity to move a game piece and/or other known or obvious forms of prizes.

The present invention includes one or more rounds of play. The duration of a round of play may be defined in any known or obvious way desired. For example, a round may be defined based on a fixed period of time (e.g., one month), a fixed number of players (e.g., 300 players), a fixed number of prizes (e.g., until an allocated cash or prize pool is depleted), or a fixed number of questions and/or compilations (e.g., until the questions and/or compilations have been presented 1, 2, 3, . . . , n times).

The Present Invention is Now Described in Operation.

FIG. 6 illustrated the basic method steps in block diagram form according to one embodiment of the present invention. During a round of play, for each player participating in the round, a player is presented with a compilation of content 100 by a contest host 20. Presentation includes selecting a compilation of content from the archive and exhibiting it for a player to review. Selection may be based on a FIFO, LIFO or random-based protocol. Preferably, the selection is random, utilizing any known or obvious random selection technique desired, in order to provide equal fairness to all participating players. For example, with a paper-based archive, sheets of paper or cards may be scattered or shuffled with a compilation being selected by hand without first looking at the content. For a computer-based archive, a similar shuffling or scattering technique may be used; or preferably, a random number may be generated and used to reference a compilation stored in the archive. Conveniently, most, if not all, computer languages include a built-in random number generation function. For example, where there are ten (10) compilations, the randomly generated number two (“2”) may be used to access the 2^{nd} compilation stored in the archive, or the 2^{nd} compilation stored in an array of data structures.

Exhibiting a compilation of content 31 may be effectuated in a plurality of ways; and notably, the form in which a compilation of content is exhibited may be dictated by the particular type of content. For example, where a content of a compilation 100 may be represented in printed form only, exhibiting may be effectuated by either physically handing a sheet of paper, card, etc. to a player for the player to read, or displaying the content on a computer monitor for the player to read. As a further example, where the content of a compilation 100 includes movie clips, animations and/or sounds (multimedia content), respective multi-media hardware must be employed. For example, exhibiting an animation would require a computer and computer screen; a projector and screen combination; a VCR player and display, etc.; and exhibiting one or more sounds would require a sound generating device (stereo/amplifier, sound card, etc.) and speaker combination.

In a network application of the present invention, exhibiting content may require the sending of a compilation of content 100 by a server (host) over the Internet to a participating player. In such an application, the content may be in the form of digital data representing text, graphics, animations, video clips, sound effects, sound bites, music, etc., and may be exhibited via a player's computer (computer screen, speakers).

Timing

IF (Compilation of content=Advertisement)

THEN

a. start timer when compilation provided, or

b. start timer when question presented.

c. no timer at all.

IF (Compilation of content=Any type of Content)

THEN

a. start timer when question presented or as closely as possible. For network-based . . . (see computer clock option above)

The player is allowed to read, view and/or hear the compilation of content before presentation of questions.

According to one embodiment, the present invention is practiced over a computer network (such as the Internet 20) with a game server 10 operatively connected to the Internet 20 and one or more players 31.1-31.i (where i≧1), each player having a remote computer 30.1-30.i operatively connected to the Internet 20.

In the foregoing specification, the invention has been described with reference to specific exemplary embodiments thereof. It will, however, be evident that various modifications and/or changes may be made thereto without departing from the broader spirit and scope of the invention. Accordingly, the specification and drawings are to be regarded in an illustrative rather than a restrictive sense.

Therefore, I claim:

1. A system for increasing the retention of advertisement information by one or more participants, said system comprising:
a first advertisement for presentation to one or more participants;
associated with said first advertisement, one or more first questions for presentation to said one or more participants, the one or more first questions involving the information contained in said first advertisement;
for each of said one or more first questions, one or more first correct answers conclusively derivable from the information contained in said first advertisement; and
a prize awarded to one or more of the one or more participants with the highest performance score.

2. The system of claim 1, said system further comprising:
a timer for measuring how fast each of said one or more participants submits answers.

3. The system of claim 1, said system further comprising:
a second advertisement for presentation to said one or more participants;
associated with said second advertisement, one or more second questions for presentation to said one or more participants, the one or more second questions involving the information contained in said second advertisement; and
for each of said one or more second questions, one or more second correct answers conclusively derivable from the information contained in said second advertisement

4. The system of claim 1, wherein said first advertisement and said one or more first questions are presented at the same time.

5. The system of claim 1, wherein said first advertisement and said one or more first questions are presented substantially at the same time.

6. The system of claim 1, wherein said first advertisement is presented before said one or more first questions are presented.

7. The system of claim 1, wherein said first advertisement is presented after said one or more first questions are presented.

8. A method for increasing the retention of advertisement information by one or more participants, said method comprising the steps of:
a) presenting to one or more participants a first advertisement;
b) presenting to said one or more participants one or more first questions involving the information contained in said first advertisement, each of said one or more first questions having an associated one or more first correct answers conclusively derivable from the information contained in said first advertisement;
c) receiving from each of said one or more participants one or more first submitted answers;
d) comparing the first submitted answers to at least one correct answer, said at least one correct answer being conclusively derivable from said first advertisement; and
e) awarding a prize to at least one of said one or more participants.
for each of said one or more first questions, one or more first correct answers conclusively derivable from the information contained in said first advertisement; and
a prize awarded to at least one of said one or more participants.

9. The method of claim 8, said method further comprising the step of:
f) before step e), measuring with a timer how fast each of said one or more participants submits the one or more first submitted answers.

10. The method of claim 8, said method further comprising the steps of:
g) before step e), presenting to said one or more participants a second advertisement;
h) before step e), presenting to said one or more participants one or more second questions involving the information contained in said second advertisement, each of said one or more second questions having an associated one or more second correct answers conclusively derivable from the information contained in said second advertisement; and
h) before step d), receiving from each of said one or more participants one or more second submitted answers.

11. The method of claim 8, where in step a) said first advertisement is presented over a first network.

12. The method of claim 8, where in step b) at least one of said one or more first questions is presented over a first network.

13. The method of claim 8, where in step c) at least one of said one or more first submitted answers is received over a first network.

14. The method of claim 8, wherein the one or more participants awarded said prize in step e) submitted the one or more first submitted answers in the shortest amount of time.

15. The method of claim 8, wherein said first advertisement and said one or more first questions are presented at the same time.

16. The method of claim 8, wherein said first advertisement and said one or more first questions are presented substantially at the same time.

17. The method of claim 8, wherein said first advertisement is presented before said one or more first questions are presented.

18. The method of claim 8, wherein said first advertisement is presented after said one or more first questions are presented.
